(19) United States
(12) Patent Application Publication
(10) Pub. No.: US 2009/0178925 A1
(43) Pub. Date: Jul. 16, 2009

(54) Chemical Sensor Based on Zinc Oxide Nanostructures for Detection of Hydrazine

(76) Inventors: Yoon-Bong HAHN, Jeonju-si (KR); Ahmad Umar, Jeonju-si (KR)

Correspondence Address: MCNEELY BODENDORF LLP, P.O. BOX 34175, WASHINGTON, DC, 20043, US

(21) Appl. No.: 12/037,912

(22) Filed: Feb. 26, 2008

(30) Foreign Application Priority Data
Jan. 14, 2008 (KR) 10-2008-0004141

(51) Int. Cl. G01N 27/26

(52) U.S. Cl. 204/412

(57) ABSTRACT

The present invention relates to a chemical sensor for detection of hydrazine. The invention detects hydrazine with a modified electrode using ZnO nanostructures such as nanonails and hexagonal-shaped nanorods by electrochemical analysis. The ZnO nanostructures are grown by simple non-catalytic thermal evaporation process in the presence of oxygen and coated on the surface of electrode. The prepared ZnO nanostructures/electrode is used as electron mediator and enhances the electron transfer between the hydrazine and electrodes and produces a high sensitivity. The most important target of this invention is to present the use of novel, cost effective and easily grown ZnO nanostructures as efficient electron mediators to modify the electrodes and fabricate the chemical sensor for effective detection of hydrazine.

### CLAIM OF PRIORITY

This application makes reference to and claims all benefits accruing under 35 U.S.C. §119 from an application for “CHEMICAL SENSOR WITH ZINC OXIDE NANOSTRUCTURES FOR DETECTION OF HYDRAZINE” earlier filed in the Korean Intellectual Property Office on Jan. 14, 2008 and there duly assigned Serial No. 10-2008-0004141.

### BACKGROUND OF THE INVENTION

1. Field of the Invention

The present invention relates to a chemical sensor, particularly for detection of hydrazine with ZnO nanostructures grown by simple non-catalytic thermal evaporation process. This invention presents the use of novel, cost effective and easily grown ZnO nanostructures as efficient electron mediators to modify the electrodes for the effective detection of hydrazine.

2. Description of the Related Art

The presented invention relates to an electrochemical detection method of hydrazine based on high-quality ZnO nanostructures such as nanonails and nanorods. An electrochemical method is generally used to identify and measure the amount of a material or chemical dissolved in the solution. The electrochemical method measures the current flowing at the electrode in an aqueous sample solution to perform qualitative or quantitative analysis of the substance dissolved in the aqueous solution. In electrochemical method, mostly, a potential is applied between the working electrode and reference electrode which are immersed in the aqueous sample solution. An oxidation/reduction (red-ox) reaction of analyte occurs on the working electrode by applying the potential and the magnitude of a current flowing due to this reaction is measured to perform analysis. The electrochemical reaction is commonly used to because of its relatively high sensitivity and easiness. Based on the mode of operation and specialized area of applications, the electrochemical sensors can be divided into three categories: potentiometric, amperometric and conductometric.

Among the different electrochemical sensors, the amperometric sensor hold special positions which are constructed on the principle based on the oxidation or reduction of electrochemically active substances involved or produced in the reactions.

These amperometric sensors are found in many forms and application areas and these operate on the principle that adsorbed ions will change the amount of current generated when a potential is applied. Hence by both applying a known potential and measuring the resulting current, specific determinations can be made regarding the adsorbed species of interest.

These amperometric devices are inherently sensitive and selective towards electroactive species, fast and accurate, compact, portable and inexpensive. Such kinds of amperometric sensors devices satisfy many of the requirements for on-site environmental analysis.

To increase the selectivity and sensitivity of amperometric sensors, artificial mediators are often used in the fabrication of sensors. The concept of modified electrodes is a field of growing interest and it has been demonstrated that chemically modified electrodes possess distinct advantages over conventional electrodes in numerous application areas including electrochemical sensors and electrocatalysis. The advantages of the chemically modified electrodes are their abilities to fasten the electron transfer electrons between the detecting species and to minimize the overpotential effects.

As far as hydrazine is concerned, it is widely used as fuels in the rocket propulsion system and has low threshold limit value (TLV) of 10 ppb. It is also used in missile systems, fuel cells, pesticides, photography chemicals, weapons for mass destruction, catalysts, emulsifiers, dyes and corrosion inhibitors, and so on. It is a neurotoxin, hence produces carcinogenic and mutagenic effects causing damages to lungs, liver, kidneys, respiratory tract infection and long-term effects on the central nervous system. In addition to this, hydrazine is added to the industrial boilers where it acts as oxygen scavengers and removes the dissolved oxygen and thus reduces the corrosion time and extends the life time of boilers. Due to the aforesaid reasons, it is highly desirable to fabricate a reliable and sensitive analytical tool for the effective detection of hydrazine. For that, the electrochemical techniques offer an opportunity for portable, cheap, and rapid methodologies. For this purpose, a variety of chemically modified electrodes, based on different electrocatalytic moieties (electron mediator species), has thus been developed for the detection of hydrazine. Generally, metal complexes are used to modify the electrodes. However, because of small dimensions and exotic properties of nanostructures which can dramatically increase the contact surface and can possess the strong binding with biological and chemical species, which could have important applications in chemical and biological researches. Recently, it is believed that the nanostructures can be used as efficient electron mediators to modify the electrodes for the effective detection of hydrazine. There is some report in the literature which demonstrated that carbon nanotubes can be used as electron mediators to modify the electrodes for the detection of hydrazine. However, there is still need to search new nanomaterials which can be cost effective, easily grown and have exotic properties and can be used as efficient electron mediators to modify the electrodes for the detection of hydrazine.

### SUMMARY OF THE INVENTION

The present invention has been made to solve the foregoing problems of the prior art and it is therefore an object of the present invention to provide an chemical sensor for the effective detection of hydrazine. The chemical sensor has been fabricated with ZnO nanostructures such as nanonails and hexagonal-shaped nanorods. The ZnO nanostructures are grown by simple non-catalytic thermal evaporation process in the presence of oxygen and coated on the surface of electrode. The prepared ZnO nanostructures/electrode is used as electron mediator and enhances the electron transfer between the hydrazine and electrodes and produces a high sensitivity.

In order to realize the above objects, the invention provides a chemical sensor for hydrazine detection, comprising: a Nafion/ZnO nanostructures/electrode; and a three-electrode performing a electrochemical analysis: a working electrode, a counter electrode and a reference electrode.

Preferably, the Nafion/ZnO nanostructures/electrode is a modified electrode with the ZnO nanostructures. More preferably, the ZnO nanostructures comprise nanonails or hexagonal-shaped nanorods.

Preferably, diameters of nanonail gradually decrese from a base to a top along its heights creating a cone-shaped structure; and the top having a hexagonal cap creating a nail-like morphology. More preferably, the diameters of the nanonail's base and top are about 100-400 nm and 10-100 nm respectively. Also the diameters of the nanonail's hexagonal cap are about 100-300 nm. Also the nanonail is single-crystalline and dominantly grown along the [0001] direction. Also the nanonail exhibits a strong near-band-edge emission at 380 nm in the room-temperature photoluminescence spectrum.

Preferably, the hexagonal-shaped nanorod is grown onto a Au-coated Si(100) substrate by thermal evaporation process using metallic zinc. More preferably, the hexagonal-shaped nanorod is formed with the six crystallographic planes where all the planes are substantially connected each other with the internal angles of 60° and contain the (0001) top facets enclosed with six equivalents of {01-10} crystal planes. Also the diagonal lengths and the heights of the hexagonal-shaped nanorod are in the range of 50-500 nm and 0.5-5 μm, respectively. Also the hexagonal-shaped nanorod is single-crystalline and dominantly grown along the [0001] direction. Also the hexagonal-shaped nanorod exhibits a strong near-band-edge emission at 380 nm in the room-temperature photoluminescence spectrum.

Preferably, the nanostructures are used as electron mediators between the hydrazine and the electrode.

More preferably, the electrode is a gold-coated electrode. Also the electrode is used as the working electrode. Also the electrode is further coated with the Nafion solution

Preferably, the three-electrode comprises metal electrode as a working electrode, platinum wire as a counter electrode and Ag/AgCl (saturated KCl) as a reference electrode. More preferably, a sensitivity of the nanonail is substantially 1.0˜8.56 μA/cm²μM. Also a detection limit is 0.1˜5 μM based on signal to noise ratio and a steady-state current shows a linear relation with the hydrazine concentration in the range of 0.1˜1.2 μM and achieves 95% steady state currents with in 2˜10 sec.

### BRIEF DESCRIPTION OF THE DRAWINGS

The above and other objects, features and other advantages of the present invention will be more clearly understood from the following detailed description taken in conjunction with the accompanying drawings, in which:

FIG. 1. Typical field emission scanning electron microscopic (FESEM) images of (a)-(d) as-grown nanonails and (e) and (f) as-grown hexagonal-shaped nanorods.

FIG. 2. Typical X-ray diffraction pattern of (a) ZnO nanonails and (b) hexagonal-shaped ZnO nanorods.

FIG. 3. (a) Low-magnification and (b) and (c) high-resolution transmission electron microscopic (HR-TEM) images of as-grown ZnO nanonails.

FIG. 4. (a) Low-magnification and (b) high-resolution TEM (HR-TEM) image of the hexagonal ZnO nanorod.

FIG. 5. Typical Raman-scattering spectra of (a) ZnO nanonails and (b) hexagonal-shaped ZnO nanorods.

FIG. 6. Typical room-temperature photoluminescence spectra of (a) ZnO nanonails and (b) hexagonal-shaped ZnO nanorods.

FIG. 7. Cyclic voltammetric sweep curves for (a) Nafion/ZnO nanonails/Au electrode and (b) Nafion/ZnO nanorods/Au electrode.

FIG. 8. (a) Amperometric response of the Nafion/ZnO nanonails/Au electrode with successive addition of hydrazine and (b) the plot of 1/Current (1/I) vs 1/Concentration (1/C) exhibiting a linear relationship with the steady state current and hydrazine concentration.

FIG. 9. (a) Amperometric response of the Nafion/ZnO nanorods/Au electrode and (b) the plot of 1/Current (1/I) vs 1/Concentration (1/C) exhibiting a linear relationship with the steady state current and hydrazine concentration.

FIG. 10. An electrochemical analyzer with a three-electrode configuration.

### DETAILED DESCRIPTION OF THE PREFERRED EMBODIMENT

The nanostructures of ZnO acquired a special place because of their diversity in properties, such as direct wide band gap (3.37 eV) at room temperature, large saturation velocity (3.2×10⁷ cm/s), high breakdown voltage, and large exciton binding energy (60 meV), and etc. These versatile properties of ZnO provide an opportunity to recognize itself as one of the most multifunctional materials; therefore can be used as ultraviolet (UV) lasers, light emitting diodes, photo-detectors, piezoelectric transducers and actuators, hydrogen storage, chemical and biosensor, surface acoustic wave guides, solar cells, photo catalysts etc. Due to exotic properties and wide applications of ZnO, it is desirable to synthesize large quantity of ZnO nanostructures with high crystal perfection and excellent qualities to explore the diverse applications of this material. Moreover, having exotic and versatile properties including biocompatibility, nontoxicity, chemical and photochemical stability, high specific surface area, optical transparency, electrochemical activities, high-electron communicating features and so on, the ZnO nanostructure as a II-VI semiconductor presents itself as one of the most promising materials for the fabrication of efficient amperometric sensor.

In this invention, we present the fabrication of hydrazine chemical sensor which was fabricated based on the amperometric technique with ZnO nanostructures as electron mediators to modify the gold electrodes, commonly used in the electrochemical laboratories. Two different kinds of ZnO nanostructures i.e. nanonails and hexagonal-shaped ZnO nanorods, synthesized by simple thermal evaporation process with metallic zinc powder in the presence of oxygen at 450-700° C., have been used to fabricate the chemical sensor for detection of hydrazine. The most important target of this invention is to present the use of novel, cost effective and easily grown ZnO nanostructures as efficient electron mediators to modify the electrodes and to fabricate the chemical sensor for the effective detection of hydrazine.

ZnO nanonails have been synthesized by a simple thermal evaporation method using metallic zinc powder as a source of zinc in the presence of oxygen without the use of any metal catalyst or additives. The source material, metallic zinc powder loaded into a reactor was rapidly heated up to the temperature ranges of 580-700° C. under a flow of high-purity nitrogen gas at the rate of 200 sccm (standard cubic centimeter per minute). When the furnace temperature reached to a desired growth temperature, the oxygen gas was introduced into the reactor at a flow rate of 10 sccm during the whole growth period. The typical growth time for the synthesis of these ZnO nanonails was 60 min. After the growth process, the white colored powders were collected from the boat for structural and optical characterization and fabrication of hydrazine sensor.

For the growth of hexagonal-shaped ZnO nanorods, a horizontal quartz tube furnace comprised of halogen lamp heating system (heating rate=10° C./s), gas inlet and pump out systems was used. Commercially available high purity metallic zinc powder (99.999%) were used as the source material for zinc in this synthesis. The source material, metallic zinc powder were loaded into a quartz boat and positioned at the center of the furnace. Au-coated (thickness=10 nm) Si (100) of 1.5×1.5 cm was used as a substrate. The Au was deposited onto the substrate by the electron beam evaporation technique. Prior to the reaction, the chamber was evacuated to 266 Pa using a rotary vacuum pump. Before starting the reaction, the substrate was pretreated in the mixed environment of hydrogen and nitrogen at the flow of 10 sccm each for 15 minutes at 500° C. After the pretreatment step, the furnace temperature was ramped up to 550° C. using the halogen lamp heating system. A high purity O₂ and N₂ were introduced inside the reactor at the flow rates in the ratio of 25 sccm and 10 sccm, respectively. The reaction lasted for 60 minutes. The substrate was placed in the temperature of 510-450° C. During the reaction, zinc vapor was heated, vaporized and transported along the N₂ carrier gas and whitish gray colored product was deposited on the substrate.

The structural properties of as-grown ZnO nanonails and hexagonal-shaped ZnO nanorods were examined using field emission scanning electron microscope (FESEM, (Hitachi S-4700)), X-ray diffraction (XRD, (Rigaku, Cu-Kα, λ=1.54178 Å)) patterns, and transmission electron microscopy (TEM, (JEM-2010, Japan, 200 kV,)), and high-resolution transmission electron microscopy (HRTEM) equipped with the selected area electron diffraction (SAED) patterns. Room-temperature Raman-scattering and photoluminescence studies, respectively measured with the Ar⁺ (513.4 nm) and He—Cd (325 nm) laser lines as exciton sources have been performed to examine the optical properties of as-grown ZnO nanostructures, i.e. nanonails and hexagonal nanorods.

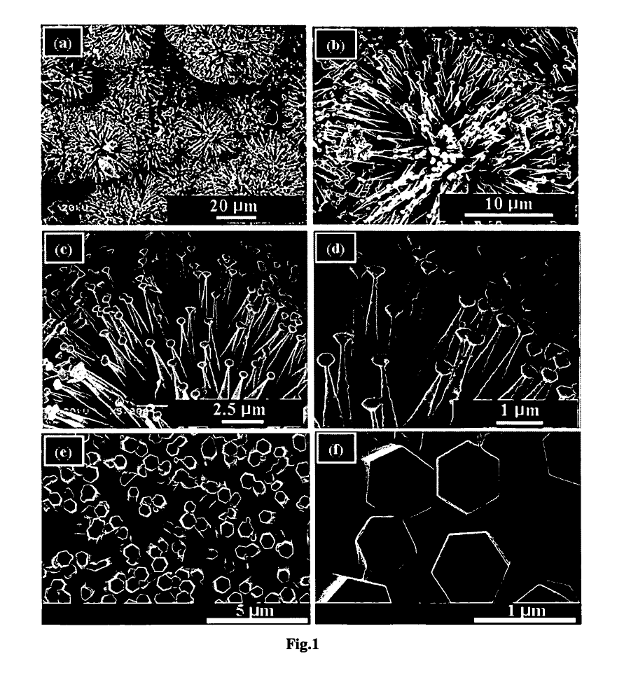

FIGS. 1(a) through (d) illustrate the typical FESEM images of the as-grown nanonails and reveal that the nanonails are grown in a very high density. Significantly, it is seen that the nanonails are arranged in such a special fashion that they are making a perfect spherical peacock-wing morphology. It is interesting to see that the diameters of the as-grown nanonail are not uniform along its heights, but it gradually decreases from a base to a top creating a cone-shaped structure and the top having a hexagonal cap creating a nail-like morphology. The diameters of the nanonail's base and top are about 320±50 nm and 60±10 nm, respectively. The diagonal lengths of the nanonail's cap are about 250±50 nm. FIGS. 1(e) through (f) demonstrate the typical FESEM images of the hexagonal-shaped ZnO nanorods grown on Au-coated Si(100) substrates and reveal that the as-grown products are regular hexagonal nanorods, vertically aligned and grown in a high density over the whole substrate surface. The typical diameters and heights of the grown products are in the range of 300-400 nm and 4-5 μm, respectively. All the nanorods are formed with the six crystallographic planes where all the planes are sumstantially connected each other with the internal angles of 60°. The as-grown nanorods contain the (0001) top facet enclosed with six equivalents of {01-10} crystal planes.

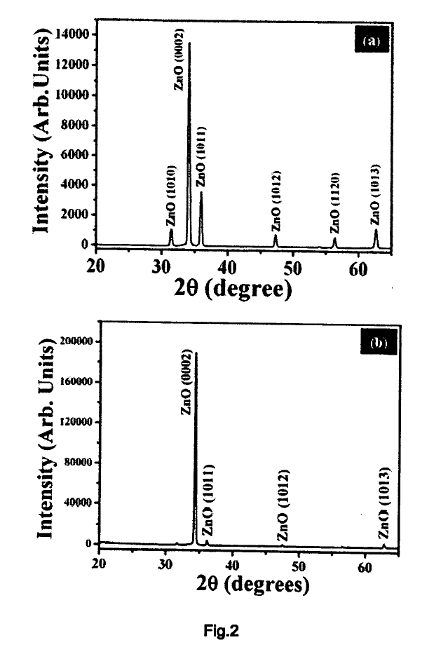

The crystalline orientation of the as-grown ZnO nanostructures was determined by the XRD analysis as shown in FIGS. 2(a) and (b). FIG. 2(a) is the typical XRD pattern for ZnO nanonails while FIG. 2(b) demonstrates the typical XRD pattern for hexagonal-shaped ZnO nanorods grown onto the Si(100) substrates. The obtained peaks from both the patterns are well matched with the diffraction peaks indexed for the wurtzite hexagonal phase of ZnO. The appearance of a sharp and strong peak at 34.2° indexed as ZnO (0002), in both the patterns confirms that the as-grown products, i.e. nanonails and hexagonal-shaped nanorods are single crystalline ZnO with the wurtzite hexagonal phase and grown in the [0001] direction.

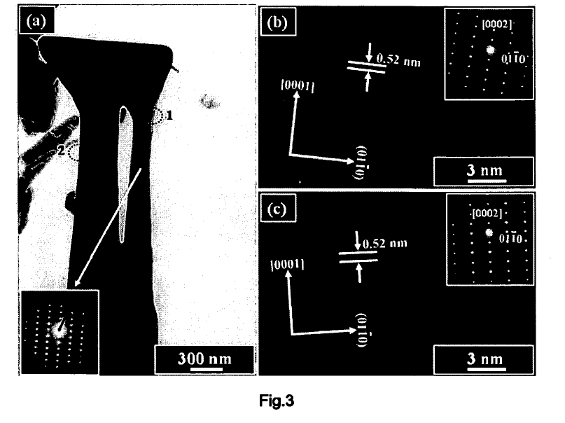

FIG. 3 exhibits the transmission electron microscopic (TEM) images of ZnO nanonails. It is seen in FIG. 3(a) that 3 or more nanonails are merged in each other, which is due to high density of nanonails. The dimensions of the nanonails are consistent with the SEM observations and the diameters of the bases and the tops of the nanonails are about 280 nm and 60 nm, respectively, while the diagonal lengths of their caps are about 200-300 nm and the heights of the nanonails are about 300 nm. The selected area electron diffraction (SAED) pattern of the single nanonail indicated by white arrow (inset in (a)), projected along the {2-1-10} zone axis, shows that the formed ZnO nanonails are single-crystalline and grown along the [0001] direction. The high-resolution TEM (HRTEM) images of the nanonails marked as 1 and 2 in FIG. 3(a) are shown in FIGS. 3(b) and 3(c), respectively. The images exhibit that the distance between two lattices fringes is about 0.52 nm, which corresponds to the d-spacing of [0001] crystal planes, and confirms that as-grown products are single crystalline with the wurtzite hexagonal phase and grown along the [0001] direction. The corresponding SAED patterns, obtained from the same position of FIG. 3(a), marked as 1 and 2, of these structures are shown in the insets of FIGS. 3(b) and 3(c), also confirming the single-crystallinity and c-axis, [0001], growth direction of the as-grown nanonails.

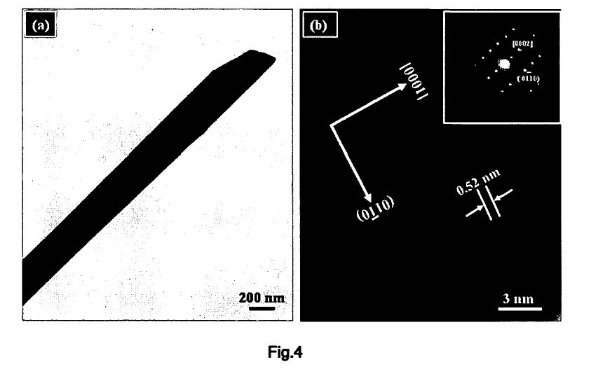

FIGS. 4(a) and (b) demonstrate the typical transmission electron microscopic images of hexagonal ZnO nanorods. The low-magnification TEM image showed in FIG. 4(a) is consistent with the FESEM examinations (FIGS. 1(e)-(f)). The diameters of obtained nanorods are in the range of 300-400 nm and the nanorods have clean and smooth surfaces throughout their heghts. The HRTEM image of the corresponding ZnO nanorod shown in FIG. 4(a) exhibits that the distances of a lattice between two fringes are about 0.52 nm, corresponding to the (0001) crystal plane of the wurtzite hexagonal ZnO. The selected area electron diffraction (SAED) pattern, projected along the [2-1-10] zone axis, of the corresponding nanorod shown in FIG. 4(a) is fully consistent with the observed HRTEM results and confirms that the obtained hexagonal-shaped ZnO nanorods are single-crystalline and grown in the [0001] direction (inset of FIG. 4(b)).

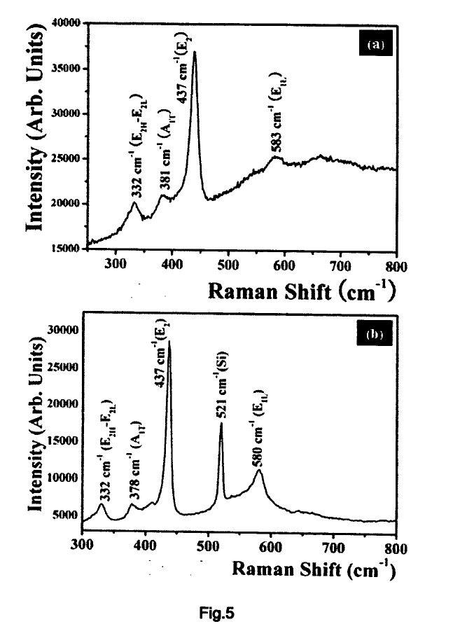

FIG. 5 shows the typical Raman-scattering spectra for the as-grown ZnO nanostructures grown by the simple thermal evaporation process. FIG. 5(a) shows the typical Raman-scattering spectrum for the as-grown ZnO nanonails while FIG. 5(b) demonstrates the typical Raman-scattering spectrum for the as-grown hexagonal-shaped ZnO nanorods. The Raman-scattering spectra of both the ZnO nanostructures, i.e. nanonails and hexagonal-shaped ZnO nanorods exhibit a strong and sharp peak at 437 cm⁻¹ which is assigned to be as Raman active non-polar optical phonon E₂ (high) mode and a characteristic peak for the wurtzite hexagonal phase ZnO as shown by T. C. Damen, S. P. S. Porto and B. Tell, “Raman effect in zinc oxide” Phys. Rev. 142, 570 (1996). Two very short and suppressed peaks are also observed in both the spectra at 332 cm⁻¹ assigned to be as E_{2H}−E_{2L} (multi phonon process) and 381 cm⁻¹ and 378 cm⁻¹, for ZnO nanonails as shown in FIG. 1(a)-(d) and hexagonal-shaped ZnO nanorods as shown in FIG. 1(e)-(f), respectively, and are attributed as A_{1T} modes as observed by J. M. Calleja and M. Cardona, “Resonant Raman scattering in ZnO” Phys. Rev. B 16, 3753 (1977). Furthermore, a suppressed and week E₁ mode in both the spectra have also been seen at 583 cm⁻¹, for ZnO nanonails shown in FIG. 1(a)-(d) and at 580 cm⁻¹ for hexagonal-shaped ZnO nanorods, demonstrated in FIG. 1(e)-(f). It is believed that the appearance of E₁ mode in the spectra is due to the structural disorder and impurities such as oxygen vacancies and zinc interstitials, etc as mentioned by C. Geng, Y. Jiang, Y. Yao, X. Meng, J. A. Zapien, C. S. Lee, Y. Lifshitz and S. T. Lee, “Well-Aligned ZnO Nanowire Arrays Fabricated on Silicon Substrates” Adv. Funct. Mater. 14, 589 (2004). Therefore, from Raman-scattering spectra, it is confirmed that the as-grown ZnO nanostructures possess wurtzite hexagonal phase with good crystal quality.

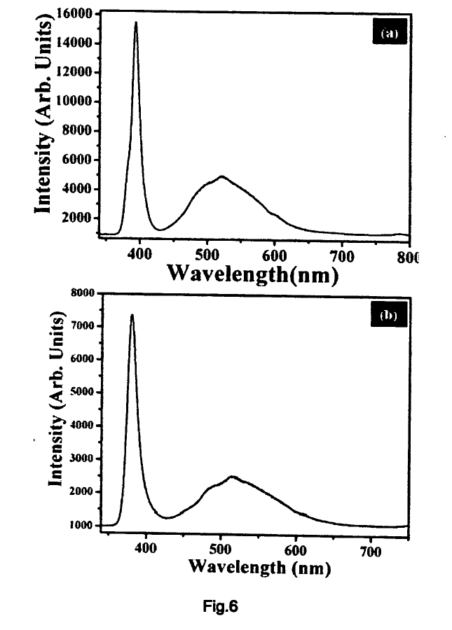

FIG. 6 shows the typical room-temperature photoluminescence spectra for the as-grown ZnO nanostructures grown by simple thermal evaporation process. FIG. 6(a) shows the typical room-temperature photoluminescence spectrum for the as-grown ZnO nanonails while FIG. 6(b) demonstrates the typical room-temperature photoluminescence spectrum for the as-grown perfectly hexagonal-shaped ZnO nanorods. In both the cases, two peaks have been appeared: a sharp, strong and dominant peak at 380 nm in the UV region, known to be as near-band-edge emission (NBE), and a suppressed, weak and broad band in the visible region at ˜520 nm, called as deep level emission (DLE). The near-band-edge emission is originated by the recombination of free excitons through an exciton-exciton collision process as described by D. M. Bagnall, Y. F. Chen, Z. Zhu, T. Yao, S. Koyama, M. Y. Shen and T. Goto, “High-temperature excitonic stimulated emission from ZnO epitaxial layers” Appl. Phys. Lett. 73, 1038 (1998) while the green emission or deep level emission is appeared due to the radial recombination of a photogenerated hole with the electron belongs to the singly ionized oxygen vacancies as observed by the K. Vanheusden, C. H. Seager, W. L. Warren, D. R. Tallant and J. A. Voigt, Correlation between photoluminescence and oxygen vacancies in ZnO phosphors” Appl. Phys. Lett. 68, 403 (1996). It is observed that the room-temperature photoluminescence spectrum intensities of both the ZnO nanostructures, i.e. ZnO nanonails shown in FIG. 1(a)-1(d) and hexagonal-shaped ZnO nanorods demonstrated in FIG. 1(e)-1(f) are not same and the nanonails room-temperature photoluminescence intensity is almost two times stronger than hexagonal-shaped ZnO nanorods room-temperature photoluminescence intensity. It was demonstrated by B. D. Yao, Y. F. Chen and N. Wang, “Formation of ZnO nanostructures by a simple way of thermal evaporation” Appl. Phys. Lett. 81, 757 (2002) that the higher intensity in the near-band-edge emission (NBE) has been observed from the ZnO nanostructures grown at higher temperatures. Therefore, the ZnO nanonails grown at higher-temperature exhibit a higher intensity in the UV emission as compared to the hexagonal-shaped ZnO nanorods grown at lower temperature.

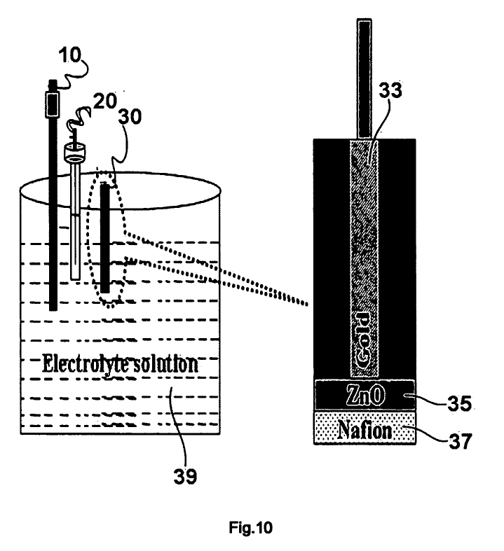

FIG. 10 shows an electrochemical analyzer with a three-electrode configuration. To fabricate the hydrazine sensor, the as-grown ZnO nanostructures 35 (i.e., nanonails and nanorods) were coated onto the surface of a gold (Au) electrodes 33, at 2.0 mm². The prepared ZnO nanostructures/Au electrode was wetted with phosphate buffer solution (0.1 M PBS) whose pH is 7.4 and dried gently by the high purity nitrogen gas. After drying the modified ZnO nanostructures/Au electrode, a 5 μl (5 weight %) Nafion solution 37 was dropped onto the electrode and dried for 24 h at 4° C. to form a thin film on the modified electrode like net-coating. For the amperometric experiments, aliquots of hydrazine (from 0.2-3 μM) were injected into the stirred electrolyte solution 39 and each addition of hydrazine resulted in a rapid increase in the current. When not in use, the ZnO nanostructures modified gold electrodes (i.e., Nafion/ZnO/Au electrodes) were stored in PBS (pH=7.4) at 4° C. The electrochemical experiments were carried out at room-temperature using an electrochemical analyzer with a conventional three-electrode configuration: a working electrode 30 (ZnO nanostructures-modified gold electrode with the area of 2 mm²), a Pt wire as a counter electrode 10 and Ag/AgCl (saturated KCl) as a reference electrode 20. Prior to the experiments, the working electrode was polished with the 0.05 μm alumina slurry and then sonicated in de-ionized water.

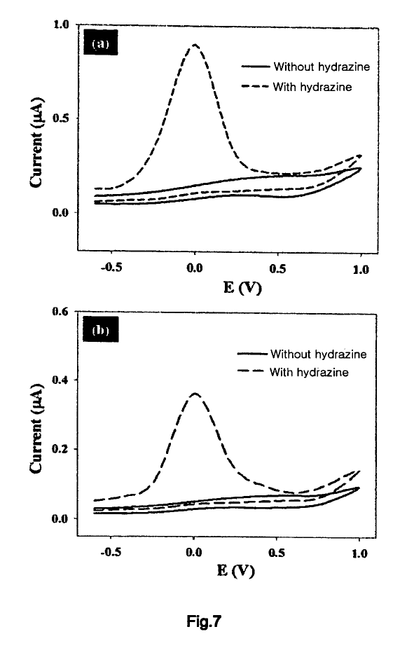

FIG. 7 shows a cyclic voltammetric sweep curve for the ZnO nanostructures-modified gold (Nafion/ZnO/Au) electrode without hydrazine (solid line) and with 1 mM N₂H₄ (dotted line) in 0.01M phosphate buffer solution (pH=7.4) at the scan rate of 100 mV/s. As the pH of solution is important to obtain the efficient electrocatalytic oxidation of hydrazine and it is well reported that by increasing the pH value of the solution (pH>7), the electrocatalytic oxidation of hydrazine increases as demonstrated by the S. V. Guerra, C. R. Xavier, S. Nakagaki, L. T. Kubota, “Electrochemical behavior of copper porphyrin synthesized into zeolite cavity: a sensor for hydrazine, Electroanalysis 10, 462 (1998) and E. F. Perez, G. O. Neto, A. A. Tanaka, L. T. Kubota, “Electrochemical Sensor for Hydrazine based in silica modified with nickel tetrasulfonated phthalocyanine” Electroanalysis, 10, 111 (1998). Thus, pH 7.4 is needed to perform all the electrochemical experiments. FIG. 7(a) shows the typical voltametric sweep curves for the modified gold electrodes with the as-grown ZnO nanonails, while FIG. 7(b) demonstrates the typical cyclic voltametric sweep curves for the modified gold electrodes with the as-grown ZnO nanorods. A well defined oxidation peak with 1 mM N₂H₄ in 0.01M PBS (dotted line) is observed, which indicates that the hydrazine is effectively oxidatively detected with the modified gold electrodes. The cyclic voltammetric sweep curves show a potential (Eₚₐ) peak of about 0.021 V and current (Iₚₐ) peak of 0.905 μA for ZnO nanonails and 0.395 μA for hexagonal-shaped ZnO nanorods. The oxidation process, from both the modified electrodes, starts around 0.4 V and the anodic peak appears at about 0.021 V. No cathodic current is observed during the reverse sweep because the electrochemical response is irreversible. According to the disclosure of C. G. Hu, W. L. Wang, S. X. Wang, W. Zhu, and Y. Li, “Investigations on electrochemical properties of carbon nanotubes” Diamon. Relat. Mater. 12, 1295 (2003), the electrochemical reaction for the hydrazine is proposed to be as N₂H₄+5/2OH⁻→1/2N₃⁻+1/2NH₃+5/2H₂O+2e. As the faster electron transfer leads to a sharper and well-defined peak, the substantial increase in the peak height reflects a faster electron-transfer reaction. Therefore, hydrazine is effectively detected by the modified gold electrode with the Nafion/ZnO nanostructures.

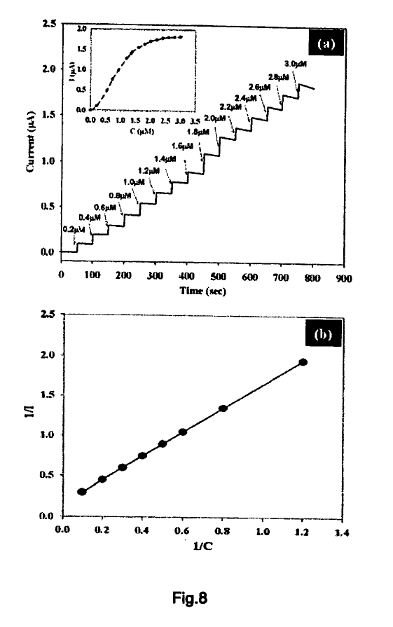

The amperometric experiments have been performed under stirring, as the amperometry under stirred conditions has a much higher current sensitivity than the cyclic voltammetry. FIG. 8(a) shows a typical amperometric response of the Nafion/ZnO nanonails/Au electrode on a successive addition of hydrazine (from 0.2-3 μM) into continuously stirred 0.01 M PBS solution (pH 7.4) at an applied potential at the range of −0.5 to 0.4 V. The amperometric sensor exhibited a rapid and sensitive response to the change of hydrazine concentration and an obvious increase in the oxidation current upon successive addition of hydrazine was obtained. The modified electrode achieved 95% steady state currents in 5 sec. This indicates a good electrocatalytic oxidative and fast electron exchange behavior of modified electrode. Inset of FIG. 8(a) shows the corresponding calibration curve of the fabricated amperometric hydrazine sensor. The response current increases as the concentration of hydrazine increases, and is saturated at a high hydrazine concentration value of about 2.6 μM. A linear relation between the steady state current and hydrazine concentration at the range of 0.1 to 1.2 μM, have been observed under optimized conditions as shown in FIG. 8(b). From the FIG. 8(b), the correlation coefficient (R) was estimated to be 0.999. Moreover, the sensitivity of the modified amperometric hydrazine sensor, from the slope of calibration curve, was 8.56 μA/cm²μM and the detection limit estimated based on signal to noise ratio (S/N) was 0.2 μM.

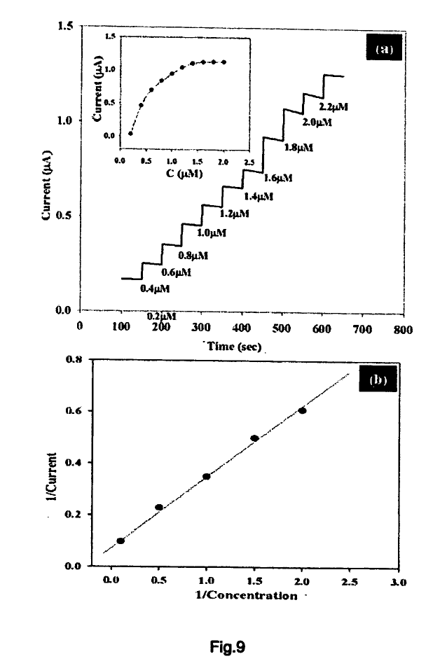

FIG. 9(a) shows a typical amperometric response of the Nafion/ZnO nanorods/Au electrode on a successive addition of hydrazine (from 0.2-2.4 μM) into continuously stirred 0.01 M PBS solution (pH 7.4) at an applied potential at the range of −0.5 to 0.4 V. A rapid and sensitive response according to a change of the hydrazine concentration and an obvious increase in the oxidation current upon successive addition of hydrazine was observed from the amperometric sensor with ZnO nanorods. The modified electrode achieved 95% steady state currents in 10 s. The response current increases as the concentration of hydrazine increases, and is saturated at a high hydrazine concentration value of about 1.65 μM. FIG. 9(b) shows the typical plot of 1/Current versus 1/Concentration which exhibits a linear relationship with the steady state current and hydrazine concentration. Moreover, under the optimized condition, a linear relation between the steady state current and hydrazine concentration at the range of 0.2 to 2.0 μM, have been observed under optimized conditions as shown in FIG. 8(b).

The correlation coefficient (R) was estimated to be 0.9914. The sensitivity of the modified amperometric hydrazine sensor with hexagonal-shaped ZnO nanorods, from the slope of calibration curve, was 4.76 μA/cm² μM⁻¹ and the detection limit was 2.2 μM. based on signal to noise ratio.

As a result of experiments of the stability and reproducibility of modified electrodes for the hydrazine using the ZnO nanostructures, it was found that the fabricated sensor could be used more than 45 days continuously if it was stored in an appropriate form when not in use.

As the ZnO nanostructures have multifarious properties such as nontoxicity, chemical and photochemical stability, high specific surface area, optical transparency, electrochemical activities, high conductivity which provide high electron communication features that enhance the direct electron transfer. Therefore, due to easy synthesis of ZnO nanostructures and easy fabrication of electrode, high-sensitivity, low detection limit, and fast response give an opportunity to our invention to present itself as one of the promising approaches to use various kinds of ZnO nanostructures for the fabrication of efficient amperometric sensor for detection of hydrazine. Moreover, it would also provide an economic way to produce cost effective electrochemical hydrazine sensor using ZnO nanostructures for industrial requirements in bulk.

It is accentuated that the above described embodiments of the present invention, described with the help of examples, are simply to describe for the clear understanding of the principles of the invention. Many modifications and variations may be made to the above described embodiment of the invention without deviating from the fundamental nature and scope of the invention.

What is claimed is:

1. A chemical sensor for hydrazine detection, comprising:
a Nafion/ZnO nanostructures/electrode; and
a three-electrode configuration to perform electrochemical analysis, including a working electrode, counter electrode and reference electrode.

2. The chemical sensor of claim 1, wherein the Nafion/ZnO nanostructures/electrode is a modified electrode with the ZnO nanostructures.

3. The chemical sensor of claim 2, wherein the ZnO nanostructures comprise nanonails or hexagonal-shaped nanorods.

4. The chemical sensor of claim 3, wherein the diameters of nanonail gradually decrese from a base to a top along its heights creating a cone-shaped structure; and
the top having a hexagonal cap creating a nail-like morphology.

5. The chemical sensor of claim 4, wherein the diameters of the base and top of the nanonail are about 100-400 nm and 10-100 nm respectively, wherein the diameters of the hexagonal cap of the nanonail are about 100-300 nm.

6. The chemical sensor of claim 3, wherein the nanonail is single-crystalline and dominantly grown along the [0001] direction.

7. The chemical sensor of claim 3, wherein the nanonail exhibits a strong near-band-edge emission at 380 nm in the room-temperature photoluminescence spectrum.

8. The chemical sensor of claim 3, wherein the hexagonal-shaped nanorod is grown onto a Au-coated Si(100) substrate by thermal evaporation process using metallic zinc.

9. The chemical sensor of claim 3, wherein the hexagonal-shaped nanorod is formed with the six crystallographic planes where all the planes are substantially connected each other with the internal angles of 60° and contain the (0001) top facets enclosed with six equivalents of {01-10} crystal planes.

10. The chemical sensor of claim 3, wherein the diagonal lengths and the heights of the hexagonal-shaped nanorod are in the range of 50-500 nm and 0.5-5 μm, respectively.

11. The chemical sensor of claim 3, wherein the hexagonal-shaped nanorod is single-crystalline and dominantly grown along the [0001] direction.

12. The chemical sensor of claim 3, wherein the hexagonal-shaped nanorod exhibits a strong near-band-edge emission at 380 nm in the room-temperature photoluminescence spectrum.

13. The chemical sensor of claim 3, wherein the nanostructures are used as electron mediators between the hydrazine and the electrode.

14. The chemical sensor of claim 13, wherein the electrode is a gold-coated electrode.

15. The chemical sensor of claim 14, wherein the electrode is used as the working electrode.

16. The chemical sensor of claim 15, wherein the electrode is further coated with the Nafion solution.

17. The chemical sensor of claim 1, wherein the three-electrode comprises metal electrode as a working electrode, platinum wire as a counter electrode and Ag/AgCl (saturated KCl) as a reference electrode.

18. The chemical sensor of claim 17, wherein a sensitivity of the nanonail is substantially 1.0˜8.56 μA/cm²μM.

19. The chemical sensor of claim 18, wherein a detection limit is 0.1˜5 μM based on signal to noise ratio and a steady-state current shows a linear relation with the hydrazine concentration in the range of 0.1˜1.2 μM and achieves 95% steady state currents with in 2˜10 sec.
